(19) United States
(12) Patent Application Publication
(10) Pub. No.: US 2026/0005959 A1
(43) Pub. Date: Jan. 1, 2026

(54) ENABLING IDENTIFICATION AND EXECUTION OF SOURCE BASED SRv6 NETWORK PROGRAMMING FUNCTIONS

(71) Applicant: Cisco Technology, Inc., San Jose, CA (US)

(72) Inventors: Amir Khan, San Jose, CA (US); Ayan Banerjee, Fremont, CA (US)

(21) Appl. No.: 18/757,340

(22) Filed: Jun. 27, 2024

(51) Int. Cl. H04L 45/74; H04L 9/40; H04L 45/42

(52) U.S. Cl. CPC H04L 45/74; H04L 45/42; H04L 63/105

(57) ABSTRACT

In one example, a method includes receiving, at a network node of a network deploying segment routing, a data packet, wherein an IPv6 header of the data packet includes a source specific function associated with a source address of the data packet and a destination specific function associated with a destination address of the data packet; determining, at the network node, whether a source flag in an End node address of the network node is set; upon determining that the source flag is set, extracting, by the network node, the source specific function; and executing, by the network node, the source specific function for the data packet.

### FIELD

The present technology generally relates to the field of computer networking, and more particularly, to systems and techniques for enabling destination nodes to identify and execute network programming functions in the context of source nodes in the context of segment routing over IPv6 data plane.

### BACKGROUND

Segment Routing over IPv6 (SRv6) network programming framework enables a network operator or an application to specify a packet processing program by encoding a sequence of instructions in the IPV6 packet header. Each instruction is implemented on one or several nodes in the network and identified by an SRv6 Segment Identifier in the packet.

SRv6 defines network functions which are executed in the context of the destination node.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example of a high-level network architecture, in accordance with some aspects of the present technology;

FIG. 2 illustrates a diagram of an example multi-cloud environment with an SRv6 overlay, according to some aspects of the present disclosure;

FIG. 3A illustrates an example IPv6 and SRv6 packet, according to some aspects of the present disclosure;

FIG. 3B illustrates a schematic diagram of an example destination field in an IPV6 and SRv6 header, according to some aspects of the present disclosure;

FIG. 4 illustrates an example segment routing in an SRv6 domain with source-specific function execution at an END node, according to some aspects of the present disclosure;

FIG. 5 illustrates an example method of SRv6 networking functions in the context of a source node, according to some aspects of the present disclosure; and

FIG. 6 is a block diagram illustrating an example of a computing system for implementing aspects of the present technology and aspects described herein.

### DETAILED DESCRIPTION

Various examples of the disclosure are discussed in detail below. While specific implementations are discussed, it should be understood that this is done for illustration purposes. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and such references mean at least one of the examples.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative, and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Aspects of the present disclosure are directed to enable an end node (e.g., a destination node) to execute an SRv6 network programming function in the context of a source node. Primitives to support function execution, at an END node, in the context of the source node will be described below.

In one example, a method includes receiving, at a network node of a network deploying segment routing, a data packet, wherein an IPV6 header of the data packet includes a source specific function associated with a source address of the data packet and a destination specific function associated with a destination address of the data packet; determining, at the network node, whether a source flag in an End node address of the network node is set; upon determining that the source flag is set, extracting, by the network node, the source specific function; and executing, by the network node, the source specific function for the data packet.

In another example, the source flag is set if a value associated with the source flag is 1.

In another example, the method further includes executing, by the network node, the destination specific function after execution of the source specific function.

In another example, the method further includes executing the destination specific function if the source flag is not set.

In another example, the source specific function is a per packet Reverse Path Forwarding (RPF) function specifying a plurality of different type of Reverse Path Forwarding checks to be performed on the data packet.

In another example, the source specific function is a source ingress replication function, which when executed, implements distributed ingress replication of the data packet to a plurality of destination addresses.

In another example, the source specific function is a role-based access control function that enables role specific policy implementation for the data packet.

In one example, a network device includes one or more memories having computer-readable instructions stored therein, and one or more processors. The one or more processors are configured to execute the computer-readable instructions to receive a data packet, wherein the network device is configured to implement segment routing and an IPV6 header of the data packet includes a source specific function associated with a source address of the data packet and a destination specific function associated with a destination address of the data packet; determine whether a source flag in an End node address of the network device is set; upon determining that the source flag is set, extract the source specific function; and execute the source specific function for the data packet.

In one example, one or more non-transitory computer-readable media include computer-readable instructions, which when executed by one or more processors of a network device, cause the network device to receive a data packet, wherein the network device is configured to implement segment routing and an IPV6 header of the data packet includes a source specific function associated with a source address of the data packet and a destination specific function associated with a destination address of the data packet; determine whether a source flag in an End node address of the network device is set; upon determining that the source flag is set, extract the source specific function; and execute the source specific function for the data packet.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As noted above, SRv6 defines network functions which are executed in the context of the destination node. However, there are instances where execution of network functions in context of Source node may be desired (i.e., the function execution happens on an END node in the context of a source node).

Example embodiments described below, provide signaling and IPv6 modifications and primitives in IPV6 and/or SR headers that would allow for execution of network functions in the context of a source address. Furthermore, non-limiting examples of source related functions to be executed at a destination node will be described.

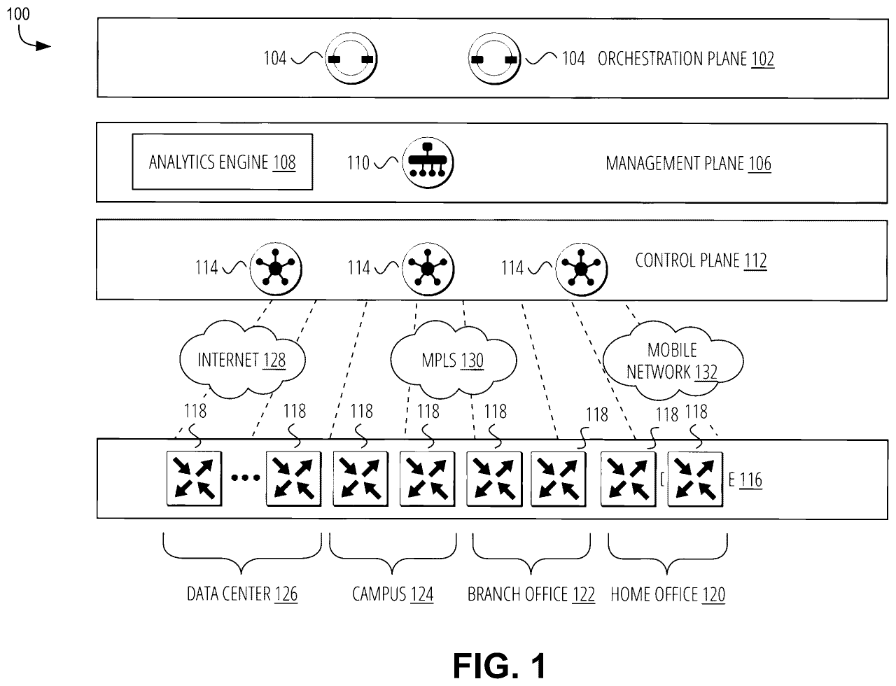

FIG. 1 illustrates an example of a network architecture 100 for implementing aspects of the present technology. An example of an implementation of network architecture 100 is the Cisco® SD-WAN architecture. However, one of ordinary skill in the art will understand that, for network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, network architecture 100 can comprise orchestration plane 102, management plane 106, control plane 112, and data plane 116. Orchestration plane 102 can assist in the automatic on-boarding of edge network devices 118 (e.g., switches, routers, etc.) in an overlay network. Orchestration plane 102 can include one or more network orchestrator appliances 104 (physical or virtual). One or more network orchestrator appliances 104 can perform the initial authentication of edge network devices 118 and orchestrate connectivity between devices of control plane 112 and data plane 116. In some embodiments, one or more network orchestrator appliances 104 can also enable communication of devices located behind Network Address Translation (NAT). In some embodiments, physical or virtual Cisco® SD-WAN vBond appliances can operate as one or more network orchestrator appliances 104.

Management plane 106 can be responsible for central configuration and monitoring of a network. Management plane 106 can include one or more network management appliances 110 (physical or virtual). In some embodiments, one or more network management appliances 110 can provide centralized management of the network via a graphical user interface to enable a user to monitor, configure, and maintain edge network devices 118 and links (e.g., one or more Internet transport network 128, MPLS network 130, 4G/Mobile network 132) in an underlay and overlay network. One or more network management appliances 110 can support multi-tenancy and enable centralized management of logically isolated networks associated with different entities (e.g., enterprises, divisions within enterprises, groups within divisions, etc.). Alternatively or in addition, one or more network management appliances 110 can be a dedicated network management system for a single entity. In some embodiments, physical or virtual Cisco® SD-WAN vManage appliances can operate as one or more network management appliances 110.

Control plane 112 can build and maintain a network topology and make decisions on where traffic flows. Control plane 112 can include one or more network control appliances 114 (physical or virtual). One or more network control appliances 114 can establish secure connections to each edge network device 118 and distribute route and policy information via a control plane 112 protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, one or more network control appliances 114 can operate as route reflectors. One or more network control appliances 114 can also orchestrate secure connectivity in data plane 116 between and among edge network devices 118. For example, in some embodiments, one or more network control appliances 114 can distribute crypto key information among edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as one or more network control appliances 114.

Data plane 116 can be responsible for forwarding packets based on decisions from control plane 112. Data plane 116 can include edge network devices 118, which can be physical or virtual edge network devices. Edge network devices 118 can operate at the edges various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). Edge network devices 118 can provide secure data plane 116 connectivity among sites over one or more WAN transports, such as via one or more Internet transport network 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). Edge network devices 118 can be responsible for traffic forwarding, security, encryption, quality of service (QOS), and routing (e.g., BGP, OSPF, etc.), among other tasks. In some embodiments, physical or virtual Cisco® SD-WAN vEdge routers can operate as edge network devices 118.

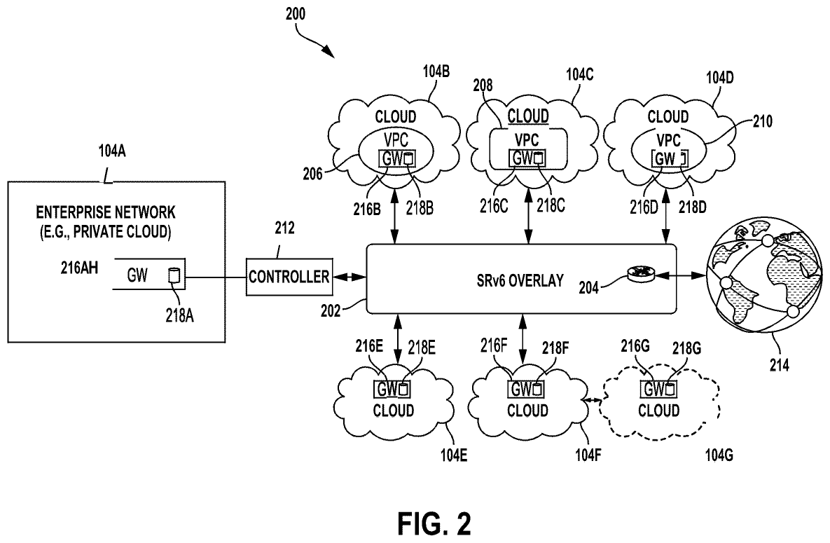

FIG. 2 illustrates a diagram of an example multi-cloud environment with an SRv6 overlay, according to some aspects of the present disclosure. Multi-cloud environment 200 includes cloud 104A, cloud 104B, cloud 104C, cloud 104D, cloud 104E, cloud 104F, and cloud 104G interconnected through SRv6 overlay 202 which routes traffic between cloud 104A, cloud 104B, cloud 104C, cloud 104D, cloud 104E, cloud 104F, and/or cloud 104G using SRv6. In this example, cloud 104A represents a private cloud or site, and cloud 104B, cloud 104C, cloud 104D, cloud 104E, cloud 104F, and cloud 104G represent public clouds. Moreover, cloud 104B, cloud 104C, and cloud 104D include virtual private clouds (VPCs) such as VPC 206, VPC 208, and VPC 210 configured for cloud 104A and hosted by cloud 104B, cloud 104C, and cloud 104D. Cloud 104E and cloud 104G, as illustrated in this example, do not include VPCs associated with cloud 104A. However, as described below, the approaches herein can allow VPCs to be created for cloud 104A on any of the cloud 104E and cloud 104G.

Controller 212 can interact with gateway 216A, gateway 216B, gateway 216C, gateway 216D, gateway 216E, gateway 216F, and gateway 216G on cloud 104A, cloud 104B, cloud 104C, cloud 104D, cloud 104E, cloud 104F, and cloud 104G, respectively. This interaction can be for purposes of collecting topology information, performing path computation, and propagating routes across cloud 104A, cloud 104B, cloud 104C, cloud 104D, cloud 104E, cloud 104F, and cloud 104G and/or VPC 206, VPC 208, and/or VPC 210. This interaction can further be for purposes of propagating segment routing identifiers (SIDs) and policies across cloud 104A, cloud 104B, cloud 104C, cloud 104D, cloud 104E, cloud 104F, and cloud 104G and/or VPC 206, VPC 208, and/or VPC 210, performing traffic engineering, etc. Controller 212 can be, for example, a BGP controller with a path computation engine. Controller 212 can reside on cloud 104A or any other network or cloud. Gateway 216A, gateway 216B, gateway 216C, gateway 216D, gateway 216E, gateway 216F, and gateway 216G can be, for example, virtual gateways available at cloud 104A, cloud 104B, cloud 104C, cloud 104D, cloud 104E, cloud 104F, and cloud 104G. In some cases, virtual gateways can include a vector packet processing engine (VPP).

Controller 212 can collect topology information from cloud 104A, cloud 104B, cloud 104C, cloud 104D, cloud 104E, cloud 104F, and cloud 104G and/or VPC 206, VPC 208, and VPC 210 and propagate forwarding rules and SR IDs (e.g., SIDs) and policies using one or more protocols such as OSPF (Open Shortest Path First), IS-IS (Intermediate System to Intermediate System), BGP Link-State (BGP-LS), BGP Traffic Engineering (BGP-TE), etc. For example, the controller 212 can collect topology information for cloud 104A, cloud 104B, cloud 104C, cloud 104D, cloud 104E, cloud 104F, and cloud 104G and/or VPC 206, VPC 208, and/or VPC 210 from gateway 216A, gateway 216B, gateway 216C, gateway 216D, gateway 216E, gateway 216F, and gateway 216G using BGP-LS protocol. Controller 212 can also include a path computation engine (PCE) for computing the best paths between gateway 216A, gateway 216B, gateway 216C, gateway 216D, gateway 216E, gateway 216F, and gateway 216G. Controller 212 can use the collected topology and/or cloud information to perform the path computation. Controller 212 can then use BGP-TE to populate reachability information, such as forwarding rules and SR IDs and policies, on gateway 216A, gateway 216B, gateway 216C, gateway 216D, gateway 216E, gateway 216F, and gateway 216G.

Gateway 216A, gateway 216B, gateway 216C, gateway 216D, gateway 216E, gateway 216F, and gateway 216G can include a control plane that interfaces with BGP-LS and BGP-TE to receive the forwarding rules and SR IDs policies from controller 212. Gateway 216A, gateway 216B, gateway 216C, gateway 216D, gateway 216E, gateway 216F, and gateway 216G can also include a data plane that processes IPv4 and/or IPv6 packets and is able to encapsulate/decapsulate IPv4 or IPv6 packets into SRv6 packets. Moreover, gateway 216A, gateway 216B, gateway 216C, gateway 216D, gateway 216E, gateway 216F, and gateway 216G can include BGP agent 218A, BGP agent 218B, BGP agent 218C, BGP agent 218D, BGP agent 218E, BGP agent 218F, and BGP agent 218G, such as GoBGP agents, to interact with controller 212 or any BGP peers. In some cases, gateway 216A, gateway 216B, gateway 216C, gateway 216D, gateway 216E, gateway 216F, and gateway 216G can also include an active measurement system based on IP SLA (Internet Protocol Service Level Agreement) to collect network performance information and monitor quality-of-service (QOS) between gateway 216A, gateway 216B, gateway 216C, gateway 216D, gateway 216E, gateway 216F, and gateway 216G.

Controller 212 can communicate with cloud 104A, cloud 104B, cloud 104C, cloud 104D, cloud 104E, cloud 104F, and cloud 104G via IPv4 or IPV6. SRv6 overlay 202 can include SRv6-capable nodes that can route traffic over SRv6 overlay 202 using SRv6 to cloud 104A, cloud 104B, cloud 104C, cloud 104D, cloud 104E, cloud 104F, and cloud 104G, and Internet 214 via router 204, as further explained below.

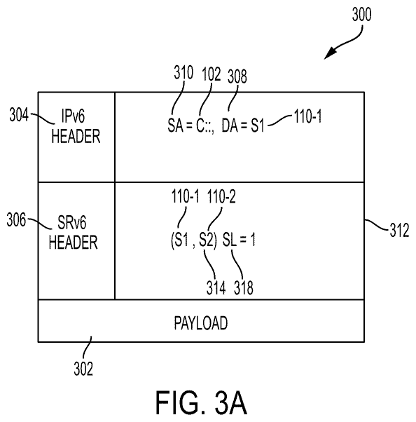

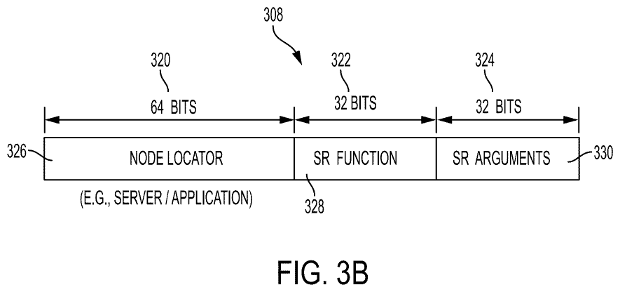

FIG. 3A illustrates an example SRv6 packet, according to some aspects of the present disclosure. SRv6 packet 300 for traffic routed via SRv6 overlay 202. SRv6 packet 300 includes a payload 302, an IPV6 header 304, and an SR header 306. SR header 306 can include a segments field 312 containing a list of segments 314 or SR list. List of segments 314 can include a set of destination nodes for SRv6 packet 300. For example, list of segments 314 can include application server 110-1 (S1) and application server 110-2 (S2) shown in FIG. 1.

The destination nodes in list of segments 314 can reside on one cloud or multiple clouds (e.g., cloud 104A, cloud 104B, cloud 104C, cloud 104D, cloud 104E, cloud 104F, and/or cloud 104G). List of segments 314 can also include a respective function for each segment, as further described below with reference to FIG. 3B.

List of segments 314 in SR header 306 can be used by nodes in SRv6 overlay 202 to steer packet 300 to the destination nodes (e.g., application server 110-1 and application server 110-2) in list of segments 314. List of segments 314 identifies each segment (e.g., SRv6-capable node) along a path for the packet. Each SRv6-capable node can maintain a list of SRv6 segments instantiated at the node. The SRv6-capable node can use its list of SRv6 segments to route the packet to the next segment in list of segments 314.

Segments field 312 can also include counter 318, known as the Segments Left, which identifies the active segment. The value of counter 318 is decreased by 1 each time it is received by an SRv6-capable node as the packet travels through the IPV6 network.

IPv6 header 304 can include source address field 310 and destination address field 308. Source address field 310 can identify the source of the packet 300, such as a client device/end terminal. Source address field 310 can include a network address of the original source of packet 300, a return destination for packet 300, and/or a current source or sender of packet 300. Source address field 310 can also include commands or functions to be implemented by the node identified in source address field 310, as will be further described below.

Destination address field 308 can identify the next segment or node from the list of segments 314. In this example, destination address field 308 identifies application server 110-1 (S1) which is the first destination node in the list of segments 314 for packet 300. Destination address field 308 can be used to steer packet 300 to the next destination. Destination address field 308 in IPV6 header 304 can allow packet 300 to be routed even if packet 300 traverses SR-unaware nodes.

Destination address field 308 can include a network prefix of the identified node or segment. For example, destination address field 308 can include physical prefix of application server 110-1 (S1). This can ensure that packet 300 is transmitted to that node or segment (e.g., application server 110-1 (S1)), as the first destination for packet 300. After the application server 110-1 (S1) processes packet 300, application server 110-1 (S1) can forward packet 300 to the next segment in list of segments 314, which in this example is application server 110-2 (S2). When forwarding the packet, application server 110-1 (S1) can overwrite destination address field 308 on IPv6 header 304 to identify application server 110-2 (S2) as the destination, which ensures that packet 300 is routed to application server 110-2 (S2). Application server 110-2 (S2) can then receive packet 300 based on destination address field 308. This way, list of segments 314 in SR header 306 as well as destination address field 308 in IPv6 header 304 can be used to push packet 300 to the destination nodes in list of segments 314.

As will be further explained, list of segments 314 and/or destination address field 308 can include functions or commands (hereinafter “SR functions”) to be implemented by associated nodes or segments. For example, destination address field 308 can identify application server 110-1 (S1) and include a function to be applied by application server 110-1 (S1), such as a connect function that application server 110-1 (S1) can interpret as a request to connect with an application or node associated with the function. Destination address field 308 can contain the state of the packet 300, including the next destination of the packet, the source or return node, and any commands or functions for such nodes or segments.

Similarly, list of segments 314 can include commands or functions for the segments in list of segments 314. For example, list of segments 314 can include a connect function for each of the destination node or segment, a force connect function for the last segment in list of segments 314, one or more parameters for one or more segments (e.g., resource identifier, flow identifier, etc.), state information, and so forth.

SR functions can encode actions to be taken by a node directly in SR header 306 and/or IPv6 header 304. SR functions are executed locally by the SRv6-capable nodes. Example SR functions include, without limitation, End (i.e., endpoint function), End.X (i.e., endpoint function with Layer-3 cross-connect), End.T (i.e., endpoint function with specific IPv6 table lookup), End.S (i.e., endpoint in search of a target in table T), End.B6 (i.e., endpoint bound to an SRv6 policy), etc. For example, in SR header (306) containing s::cj, s::cj denotes the shortest-path to the node s and an x-connect function (function c) to the neighbor j.

In some examples, each node can be assigned an entire IPv6 prefix. Accordingly, the lower-order bytes in the prefix can be used to designate different SR functions. In some cases, the SR functions may depend on the address of the first segment in list of segments 314 (e.g., the “sender” of the function). To illustrate, when a node whose physical prefix is s receives a packet with the SR header 306 containing (x, . . . , s::ƒ, . . . ), the SR header 306 will trigger node s to perform a function ƒ with argument x, denoted by s.f(x).

FIG. 3B illustrates a schematic diagram of an example destination address field in an IPv6 header, according to some aspects of the present disclosure. Destination address field 308 can include 128 bits, which can be segmented to include first segment 320 from the first 64 bits for node prefix 326, second segment 322 from the next 32 bits for an SR function 328, and third segment 324 from the next 32 bits to include any arguments 330 for SR function 328. While this example illustrates destination address field 308 segmented into a segment of 64 bits, a segment of 32 bits, and a segment of 32 bits, it should be noted that the destination address field 308 allows for flexible bit selection and thus can be segmented in other ways. The example in FIG. 3B is provided for illustration and explanation purposes.

Node prefix 326 can include the physical prefix of the next segment or node. SR function 328 can include a command or function associated with the node prefix 326. In some cases, third segment 324 can be further segmented into sub-segments which can include arguments for SR function 328. The arguments can be used to pass specific parameters for SR function 328.

As noted above, SRv6 defines network functions which are executed in the context of the destination node. Aspects of the present disclosure are directed to enabling an END node to execute an SRv6 network programming function in the context of a source node (and optionally in the context of the destination node as well). Primitives to support function execution, at an END node, in the context of the source node will be described below.

In the context of the present disclosure, source specific functions may be carried in the same manner as existing END node functions, the only difference being that they are carried in source IPV6 address instead of destination IPv6 address. These functions may be referred to as source SIDs. A source SID may have the same format as any other SID (e.g., as described above with reference to FIG. 3B.

As any regular SID which is divided into Locator, Function and Argument part, the Source SID is no different and would carry Locator, Function and Argument as well.

In order to enable an END node to be aware of the presence of these source functions, a corresponding indicator may be included in the SRH are known. This information can be carried in one a Segment Routing Header (SRH) and/or a bit within the destination function at a specific location. This can be done via capability negotiation compatibility with existing deployments. Carrying an indication in the destination function can be implemented as follows.

As S-bit indication may be carried in the argument field of an existing END function.

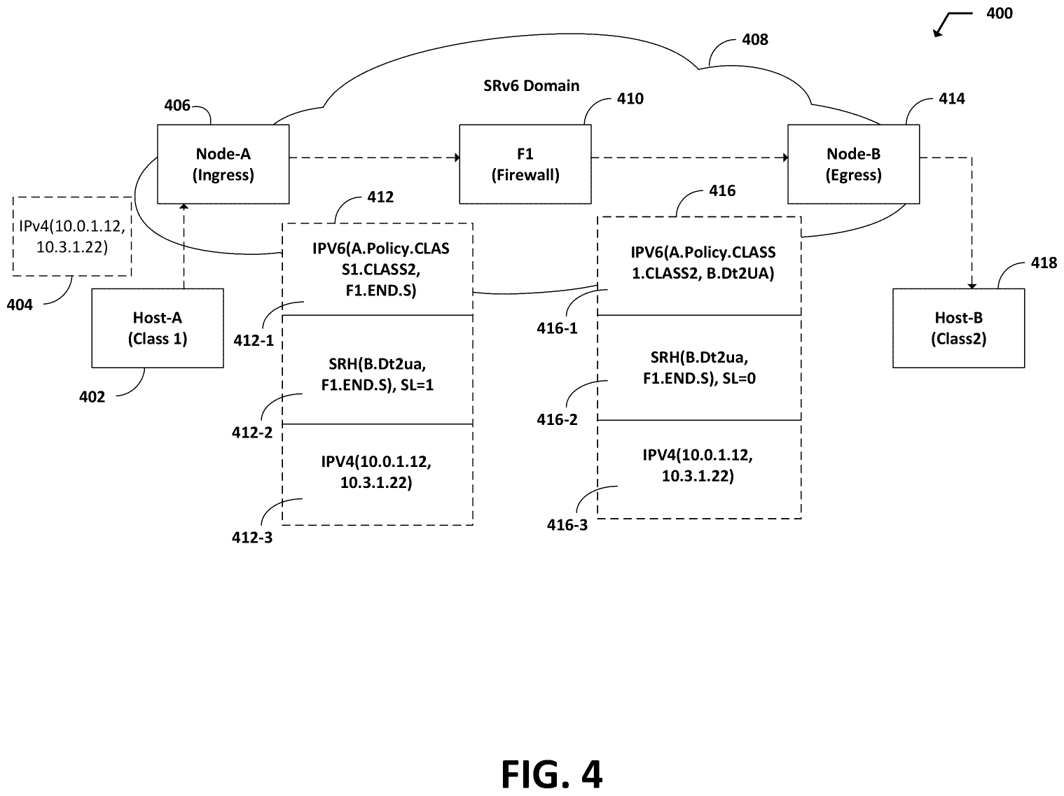

END.XX.Arg-S-bit may be defined such that END.XX.Arg-S-bit is a generic END function where “XX” can be any defined END functions including, but not limited to, DT4, DT6, DT2U, DT2M, etc. and may also carry an argument field with a newly defined S-bit set, this bit indicates that the Source-IPV6 SID carries a function and needs to be examined at the END node (hence implementing execution of network functions at an END node in the context of a source node). An END node may not necessarily be a final destination of a data packet, as is the case in the non-limiting example of FIG. 4 described below. However, if a particular END node is the final destination, then the END node is the destination node for the data packet.

As an example, when a node N receives a packet whose IPV6 Destination Address (DA) is S and S is a local END.XX.Arg-S-Bit SID, node N may perform the following:

IF Arg-S-bit set;; Ref1
Check the Source-IPv6 SID and extract the source function and any arguments withit.
Execute the Source Specific function followed by the execution of END node function.

### ELSE

Continue with END.XX functionality.

In the example IF-ELSE statement above, Ref1 indicates that the END node needs to execute both SOURCE and destination defined functions. In one example, execution of the SOURCE defined function (source-specific function) may be given a priority over execution of the destination defined function (destination-specific function).

Hereinafter, a few example source-specific functions (source-specific network programming functions) will be described. However, it should be understood that these example source-specific functions are non-limiting and other known or to be developed source-specific functions are within the scope of coverage of the present disclosure.

One example of a source-specific function is Function-A defined below:

### [Function-A] Per Packet RPF Control:

SRC.RPF.Arg-LS-bit: SRC.RPF.Arg-LS-bit is source specific function which defines per packet Reverse Path Forwarding (RPF) control. The function offers per packet granularity for performing RPF checks. Generally, the RPF type is tied to a Bridge Domain and applies to all packets coming to that BD. Having a source specific RPF function makes it more granular and offers per packet RPF control.

In the context of example Function-A, when a node N receives a packet whose IPV6 DA is S and S is a local End.XX.Arg-S-bit SID, node N may perform the following:

### IF Arg-S-bit set

Check the Source-IPv6 SID and extract the source function and Arg.LS-bit from argument.
If the Source Function is SRC.RPF.Arg-LS-bits, then:
1. Perform RPF check based on the below Arg.LS bits setting.
   LS: 00→Default option, follow whatever the BD RPF type tells you to do.
   LS: 01→Perform Strict RPF check for this packet.
   LS: 10→Perform Loose RPF check for this packet.
   LS: 11→Skip RPF check for this packet.

### ELSE

Continue with END.XX functionality.

Assuming that the deployment calls for strict RPF checks for flows coming in from an interface at a node. However, an intermediate node on being aware of a topology change may be able to mark the packets differently for a transient period of time. Such per packet RPF control aids these packets to be accepted at the destination node by marking them loose or skipping RPF checks even when they have taken an alternate path to the destination node. The intermediate node may mark such packets for transient periods that allows for the control plane to converge at all nodes in the network.

The above syntax shows support a function based on the source context by performing some extra processing for a transient time. In another example, per packet RPF control is also used in source based Distributed Ingress Replication (DIR) feature.

Another example of a source-specific function is Function-B defined below:

### [Function-B] Source Ingress Replication:

SRC.DIR.Arg-RepId-LS-bits: SRC.DIR.Arg-RepId-LS-bits is a source specific function which is to be executed by an ENDPOINT. The function assist in performing Source based distributed Ingress Replication (DIR).

In the context of example Function-B, when a node N receives a packet whose IPV6 DA is S and S is a local End.XX.Arg-S-bit SID, node N may perform the following:

### IF Arg-S-bit set

Check the Source-IPv6 SID and extract the source function, RepID, and LS bits from argument.
If the Source Function is DIR.Arg-Repld.LS-bits, then:
1. Perform RPF check based on the LS bits setting.
2. Perform Distributed IR on behalf of Source by doing (SIP, Repld) lookup to get next node in the replication list.
3. Send a copy of the packet to the updated DIP=NextNodeIP in replication list, with SIP remaining unchanged.

### ELSE

Continue with END.XX functionality.

In any ingress replication scheme, it is generally preferred to support assisted replication along a tree so that one single node does become a bottleneck in terms of having to replicate a large number of copies. With example embodiments described herein, it is possible to embed this information in the IPV6-SA and direct this to the next node along the assisted replication tree. A tree built with constraints that satisfies degree and depth constraints can make use of this feature to efficiently send packets to intended destinations.

Another example of a source-specific function is Function-C defined below:

### [Function-C] Role Based Access Control:

SRC.Policy.Arg-PolicyID: SRC.Policy.Arg-PolicyID is a source specific function which enables u policy-based lookup for SRv6. The function helps in deploying segmentation of user traffic in the same domain based on user role (determined during authentication). The function also carries the 16-bit policy-id as argument field.

In the context of example Function-C, when a node N receives a packet whose IPV6 DA is S and S is a local End.XX.Arg-S-bit SID, node N may perform the following:

### IF Arg-S-bit set

Check the Source-IPv6 SID and extract the source function and Arg.LS-bit from argument.
If the Source Function is SRC.Policy.Arg-PolicyID then:
1. Extract policy-ID from argument field and perform a policy-based lookup.
2. Act based on defined policy.

### ELSE

Continue with END.XX functionality.

In one example, a variant of SRC.Policy.Arg-PolicyID can be SRC.Policy.Arg-SCLASS.DCLASS, where source class (SCLASS) & destination class (DCLASS) are 16-bit each, being carried in Argument field. One of the applications of SRC.Policy.Arg-PolicyId could be Penultimate Segment Pop (PSP) Node deployed firewall.

FIG. 4 illustrates an example segment routing in an SRv6 domain with source-specific function execution at an END node, according to some aspects of the present disclosure.

In example 400 of FIG. 4, one or more data packets may be sent from source node 402 (host-A) to destination node 418 (host-B) over SRv6 domain 408 (may be the same as overlay 202). Source node 402 may have IPv4 address 404.

Ingress node 406 (node-A) may identifies the source class as Class1 and destination class as Class2. Ingress node 406 may encode Class1 and Class2 into SRv6 Source ID before sending a data packet to firewall node 410 (F1). Firewall node 410 may be a PSP node. In this non-limiting example, firewall node 410 is an END node.

Data packet 412 may then be sent by ingress node 406 to firewall node 410. Data packet 412 may include IPv6 header 412-1, SRH 412-2, IPv4 header 412-3, and a payload (not shown in FIG. 4 but described with reference to payload 302 in FIG. 3A). As shown, Class1 and Class 2 are encoded into IPv6 header 412-1.

Ingress node 406 may send data packet 412 to firewall node 410 with DA=F1.END.S of firewall node 410 (DA may be referred to as END node address of an END node). Firewall node 410, on receiving data packet 412, checks the IPV6 DA (determines if the S bit in the END node function specified in DA is set) and executes SRC.Policy.Arg-SCLASS.DCLASS. Based on defined policy for Class1 and Class2, firewall node 410 either drops or permits data packet 412 to proceed to egress node 414.

Upon making a determination as to whether to allow or drop data packet 412, firewall node 410 may update encapsulation of data packet 412, resulting in data packet 416. More specifically, firewall node 410 may update IPv6 header 416-1 of data packet 416 to update DA with SRH address of egress node 414 and decrement SRH counter (SL) to zero (0) as shown in updated SRH header 416-2. IPv4 header 416-3 may remain the same as IPv4 header 412-3.

Upon receiving data packet 416, egress node 414 may decapsulate data packet 416 per known or to be developed processes before sending the same to destination node 418.

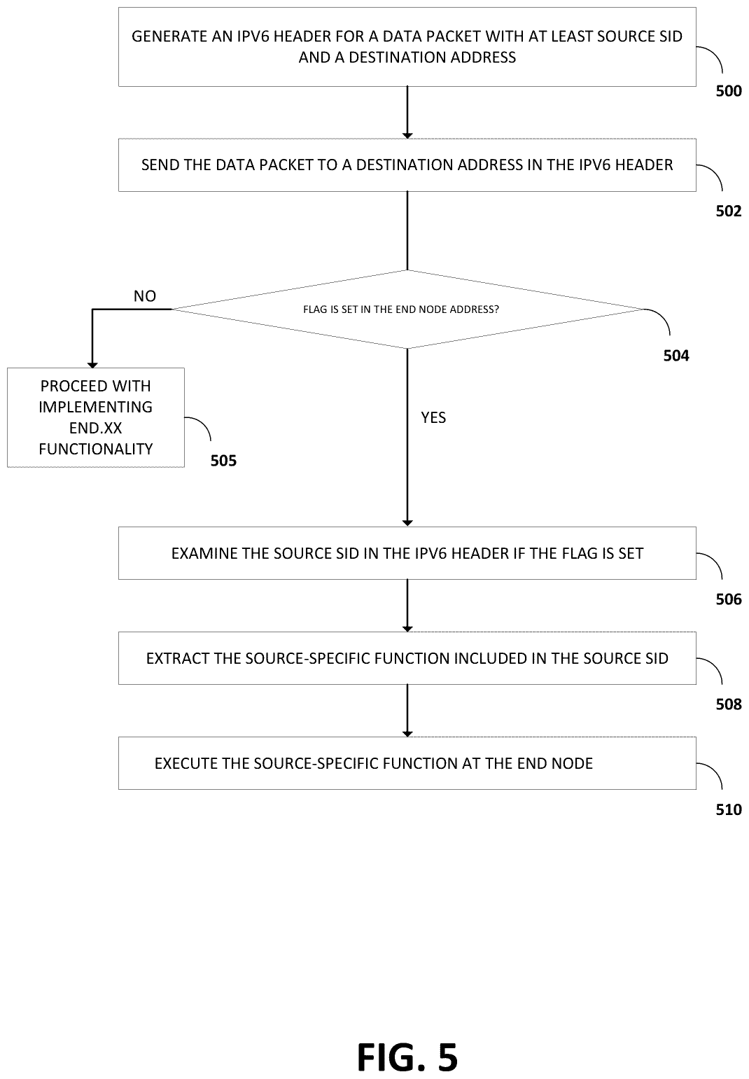

FIG. 5 illustrates an example method of SRv6 networking functions in the context of a source node, according to some aspects of the present disclosure.

At step 500, a network node (e.g., ingress node 406 or alternatively, source node 402 when source node 402 is an IPV6-based node) may generate an IPv6 header for a data packet originating at a source node (e.g., source node 402) destined for a destination node (e.g., destination node 418).

In one example, an IPV6 header may include SRv6 source SID for a data packet. The source SID may specify a source function associated with source node 402. The source function may be any one of the example source functions described above or alternatively can be any known or to be developed source function. In example of FIG. 4, the source-specific function included in data packet 412 is a role based access control function for source A. This is shown as A.Policy.Class1.Class2 in IPV6 header 412-1, which is an example of SRC.Policy.Arg-SCLASS.DCLASS described above with reference to example Function-C.

In another example, source SID may also include, in addition to a source-specific function, a destination-specific function as well.

In addition, the network node may include a DA in the SRv6 header of the data packet. In non-limiting example of FIG. 4, IPv6 header 412-1 has DA set to F1.END.S. In this example, S bit is set (e.g., set to 1).

At step 502, the network node may send the data packet to the DA (e.g., firewall node 410 in FIG. 4). The DA may correspond to the address of a receiving node (also referred to as an END node).

At step 504, the END node (e.g., firewall node 410) determines if a flag (e.g., S bit) in an End node address of the network node is set (e.g., a value of the flag is set to 1) in the DA of IPV6 header 412-1 of the received packet.

If not, at step 505, firewall node 410 continues with implementing END.XX functionality as defined. The flag may also be referred to as a source flag.

However, if set, at step 506, the END node examines the source SID included in IPV6 header.

At step 508, the END node extracts a source-specific function included in the source SID (e.g., A.Policy.Class1.Class2).

At step 510, the END node executes (implements) the extracted source-specific function. In example of source-specific function being a role-based access control, the END node executes (implements) policy-based access control based on respective policies defined according to Class1 and Class2. Such control can include permitting the underlying data packet to be forwarded to the next node (e.g., egress node 414) in the segment routing path or be dropped.

In another example, if the IPV6 header includes a destination-specific function, the END node may further execute the destination-specific function (e.g., END.XX functionality). In one example, destination-specific function may be performed if S bit (flag) described with reference to step 504 is not set (e.g., set to zero).

Thereafter, the packet may either be modified and forwarded to the next node on the path (e.g., data packet 416, as modified, to egress node 414 as described with reference to FIG. 4), if there is a next node for the packet to be forwarded to. If not, the process may end.

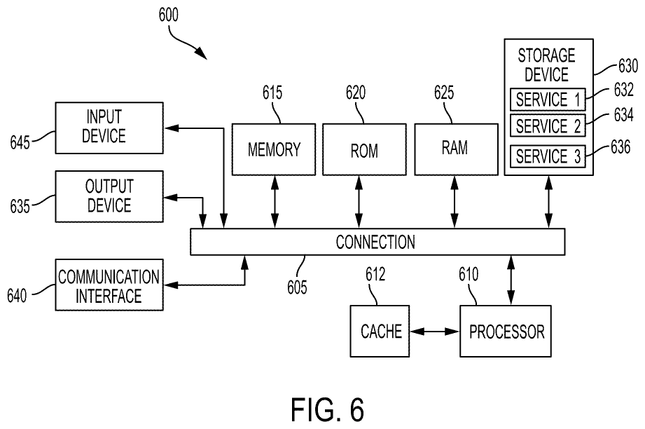

FIG. 6 illustrates a computing system architecture, according to some aspects of the present disclosure. Components of computing system 600 are in electrical communication with each other using a connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) such as processor 610 and connection 605 that couples various system components including system memory 615, such as read-only memory (e.g., ROM 620) and random-access memory (e.g., RAM 625) to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement, and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
receiving, at a network node of a network deploying segment routing, a data packet, wherein an IPV6 header of the data packet includes a source specific function associated with a source address of the data packet, a destination specific function associated with a destination address of the data packet;
determining, at the network node, whether a source flag in an End node address of the network node is set;
upon determining that the source flag is set, extracting, by the network node, the source specific function; and
executing, by the network node, the source specific function for the data packet.

2. The method of claim 1, wherein the source flag is set if a value associated with the source flag is 1.

3. The method of claim 1, further comprising:
executing, by the network node, the destination specific function after execution of the source specific function.

4. The method of claim 1, further comprising:
executing the destination specific function if the source flag is not set.

5. The method of claim 1, wherein the source specific function is a per packet Reverse Path Forwarding function specifying a plurality of different types of Reverse Path Forwarding checks to be performed on the data packet.

6. The method of claim 1, wherein the source specific function is a source ingress replication function, which when executed, implements distributed ingress replication of the data packet to a plurality of destination addresses.

7. The method of claim 1, wherein the source specific function is a role-based access control function that enables role specific policy implementation for the data packet.

8. A network device comprising:
one or more memories having computer-readable instructions stored therein; and
one or more processors configured to execute the computer-readable instructions to:
receive a data packet, wherein the network device is configured to implement segment routing and an IPv6 header of the data packet includes a source specific function associated with a source address of the data packet and a destination specific function associated with a destination address of the data packet;
determine whether a source FLAG in an End node address of the network device is set;
upon determining that the source flag is set, extract the source specific function; and
execute the source specific function for the data packet.

9. The network device of claim 8, wherein the source flag is set if a value associated with the source flag is 1.

10. The network device of claim 8, wherein the one or more processors are further configured to execute the computer-readable instructions to execute the destination specific function after execution of the source specific function.

11. The network device of claim 8, wherein the one or more processors are further configured to execute the computer-readable instructions to execute the destination specific function if the source flag is not set.

12. The network device of claim 8, wherein the source specific function is a per packet Reverse Path Forwarding function specifying a plurality of different types of Reverse Path Forwarding checks to be performed on the data packet.

13. The network device of claim 8, wherein the source specific function is a source ingress replication function, which when executed, implements distributed ingress replication of the data packet to a plurality of destination addresses.

14. The network device of claim 8, wherein the source specific function is a role-based access control function that enables role specific policy implementation for the data packet.

15. One or more non-transitory computer-readable media comprising computer-readable instructions, which when executed by one or more processors of a network device, cause the network device to:
receive a data packet, wherein the network device is configured to implement segment routing and an IPV6 header of the data packet includes a source specific function associated with a source address of the data packet and a destination specific function associated with a destination address of the data packet;
determine whether a source flag in an End node address of the network device is set;
upon determining that the source flag is set, extract the source specific function; and
execute the source specific function for the data packet.

16. The one or more non-transitory computer-readable media of claim 15, wherein execution of the computer-readable instructions further cause the network device to execute the destination specific function after execution of the source specific function.

17. The one or more non-transitory computer-readable media of claim 15, wherein execution of the computer-readable instructions further cause the network device to execute the destination specific function if the source flag is not set.

18. The one or more non-transitory computer-readable media of claim 15, wherein the source specific function is a per packet Reverse Path Forwarding function specifying a plurality of different types of Reverse Path Forwarding checks to be performed on the data packet.

19. The one or more non-transitory computer-readable media of claim 15, wherein the source specific function is a source ingress replication function, which when executed, implements distributed ingress replication of the data packet to a plurality of destination addresses.

20. The one or more non-transitory computer-readable media of claim 15, wherein the source specific function is a role-based access control function that enables role specific policy implementation for the data packet.
